(19) United States
(12) Patent Application Publication
(10) Pub. No.: US 2006/0193030 A1
(43) Pub. Date: Aug. 31, 2006

(54) Passive multi-planar displays and methods for their construction

(75) Inventor: Joe Babas, New York, NY (US)

Correspondence Address: OSTROLENK FABER GERB & SOFFEN, 1180 AVENUE OF THE AMERICAS, NEW YORK, NY, 100368403, US

(73) Assignee: POPS 3D LLC

(21) Appl. No.: 11/351,174

(22) Filed: Feb. 9, 2006

Related U.S. Application Data
(60) Provisional application No. 60/651,699, filed on Feb. 9, 2005.

(51) Int. Cl. G02B 26/00

(52) U.S. Cl. 359/295

(57) ABSTRACT

A method for creating passive, multi-planar volumetric displays comprises a system for mapping, extracting and distorting particular cross sectional information from a two-dimensional source. When this cross sectional information is printed on stacked transparent substrates, and the substrates are properly arrayed, the illusion of form is created in true 3D.

### CROSS-REFERENCE TO RELATED APPLICATIONS

This application is based upon and claims priority of U.S. Provisional Ser. No. 60/651,699 filed Feb. 9, 2005, the disclosure of which is incorporated by reference. U.S. Provisional Ser. No. 60/543,535 filed Feb. 10, 2004 is also incorporated by reference.

This application is related to Ser. No. 11/______ filed by the same inventor on even date herewith, titled A FOLDING VOLUMETRIC DISPLAY, Attorney Docket P/3659-4, also incorporated by reference.

### BACKGROUND OF THE INVENTION

1. Field of the Invention

The present invention relates to passive, multi-planar volumetric displays, and, more particularly, to a method and a system for mapping, extracting and distorting particular cross sectional information from a two-dimensional source so that when this cross sectional information is printed on stacked transparent substrates, and the substrates are properly arrayed, the illusion of three-dimensional form is created.

2. Related Art

The idea of creating a three-dimensional effect by displaying information on multiple layers is well-known in the art and can be traced back to Maratta, U.S. Pat. No. 678,012, where three-dimensional cutouts, representing different parts of a scene, are arrayed in space. Wiederseim in U.S. Pat. No. 956,916 and Foley in U.S. Pat. No. 2,565,553 also use cutouts to indicate space or distance or perspective. This approach, however, creates an impression with no continuity of depth, and it deals with space but not form.

Porter, U.S. Pat. No. 3,314,180, displays the actual materials of his subject arranged in successive layers and achieves a continuity of depth but, because his approach is limited in its subject matter, it lacks flexibility of application, and his technique doesn't lend itself to production in volume.

Flax, in U.S. Pat. No. 3,829,998, discloses layers of cellophane, with indicia, mounted in a folding box. Although this technique may lend itself to volume production, it suffers from not offering continuity of depth or flexibility of application or significant scalability.

Karras, U.S. Pat. No. 4,134,104, shows an arrangement of multiple layers, held in a skeletal frame, which contain cross sectional information in the form of contour lines. The lines indicate the boundaries of a form, but the eye sees them as separate layers.

Jacobsen, in U.S. Pat. No. 5,181,745, discloses a high-volume printing method that laminates multiple layers to give the illusion of depth. But the depth is not continuous and the technique is incapable of depicting form.

Schure, U.S. Pat. No. 4,173,391, Leung, U.S. Pat. No. 5,745,197, and Sullivan, U.S. Pat. No. 6,466,185 B, all disclose devices that employ sophisticated optical and/or electronic means to generate multi-planar volumetric displays capable of full motion and compelling continuity of depth. But each device limits the scale of its display. And although these devices have military, scientific and graphics applications, they are extremely expensive to manufacture.

Thus, it is known in the art that the representation of a given three-dimensional form can be created by reconstituting cross-sectional information derived by cutting flat, evenly spaced parallel planes through that form. If that sampled, cross-sectional information is properly recreated in a viewing device with flat, evenly spaced parallel planes, a representation of the original three-dimensional form can be created in true 3D. The known methods, however, have the drawbacks mentioned above. More precisely, they deal with the representation of a three-dimensional effect rather than the creation of three-dimensional illusion.

### SUMMARY OF THE DISCLOSURE

The present inventor has discovered that advantages can be obtained by sampling image information in a particular way in any one of a range of different cross-sectional configurations, and reproducing the information in a viewing device whose layers recreate the configuration of the sampled cross-sections, can create a three-dimensional illusion superior to those displays known in the prior art.

For instance, the cross sectional information may be derived from flat, parallel planes that are not evenly spaced; or from flat planes that are not parallel; or from surfaces that are not flat but that are curved in some fashion.

By such means, this invention is able to produce passive, multi-planar volumetric displays that provide the illusion of an object in space with seamless continuity of depth and that are realistic in their effect.

The volumetric displays of this invention are scalable over a wide range. The embodiments can be very small, such as illusions for pieces of jewelry; or very large, such as illusions for window displays or public sculpture.

These displays are flexible in their application to different markets including: consumer products, promotion, advertising and display. They can be embodied in forms such as greeting cards, magazine inserts, illusions in transparent boxes or as illusions embedded in a clear medium such as polyester or acrylic.

When printed with transparent media, the impact of the displays profits the most from back light, although they can also be lit effectively with both top and/or bottom light. When printed with opaque media, such as transparent ink over a white ground, the displays are most effectively lit from the top and/or the bottom.

The display takes on a different character and requires different processing techniques depending on whether the image information will be rendered in transparent or opaque media.

For instance, cross sections taken from radiological procedures, such as PET or MRI scans, can be transferred to transparent substrates and stacked in appropriately spaced parallel planes to create a three-dimensional illusion of the interior of a human body.

Conversely, cross sections can be taken from a two-dimensional source, such as a photograph, and rendered with transparent or opaque media on a transparent substrate such that the final effect will be that of rendering only surface. When transparent media are used in this method, the image information in preceding cross sections (the image information in the layers that will be closest to the viewer) is subtracted from subsequent cross sections (the image information in the layers that will be further away from the viewer); and the finished display is most effectively lit from behind.

However, when opaque media are used in this method, the image information in each cross section is utilized in full, thereby repeating much of the information layer to layer; and the finished display is most effectively lit from the top or bottom.

The displays are flexible in their manufacture for different applications and in different quantities.

This disclosure describes a method for mapping, extracting and distorting cross sectional image information from a two-dimensional source so that it can be transferred to flat or convexly curved transparent layers to create the illusion of three-dimensional form.

The disclosed embodiment of the invention employs a method for deriving cross sectional information by using flat planes or curved planes configured as a set of approximately catenary-shaped curves.

Advantageously, some of the described volumetric displays can be shipped flat and activated by “popping” them into a three-dimensional configuration.

Although the described method concentrates on a layer configuration whose cross sections comprise nested catenary curves, the approach of the invention applies, in general, to layer configurations of any shape. In this disclosure the term “catenary” curve is used broadly to include any curve that is approximately catenary-shaped, including a parabolic curve or the like, and that can be used to create an effective display.

The disclosed embodiment of the invention is implemented in this example with Adobe Photoshop 7.1 and Adobe Illustrator CS and uses elements such as menu choices, tools, settings, keyboard commands, filter options, etc. from that software. The computer terminology used herein to describe the interface relates to a Macintosh G4 computer running OS X (v. 10.2.8). The invention is not limited, however, to either that software or that hardware.

For the cross sections of an image to most effectively merge to create the illusion of form, the image information on each layer is “feathered” as described below to achieve effective blending.

If the layers of the display are curved, the image information on each layer is distorted to a different degree, consistent with each layer's curvature, to accommodate the fact that the information is derived from a flat surface and will be displayed on a curved surface.

If display layers are flat planes parallel to one another, the extracted image information is feathered, but it is not distorted because it is being transferred from one flat parallel plane to another.

To begin, the attributes of a layer configuration are chosen relative to a certain image so as to create a particular desired effect. The number of layers, the depth of their curvature and the spacing between the layers all contribute to a final impression.

A display can be configured from a varying number of layers according to the final effect desired. This disclosure will present a simplified example of a configuration comprised of five curved layers: a first, or front, layer of extreme curvature; second through fourth middle layers of decreasing curvature; and a fifth, and last, layer that is flat. In the example, the layers are oriented in the disclosed arrangement so that when viewed from the front, they curve from side to side rather than from top to bottom; and they project toward the viewer.

Other features and advantages of the present invention will become apparent from the following description of embodiments of invention that refer to the accompanying drawings.

### BRIEF DESCRIPTION OF THE DRAWINGS

FIGS. 1A-1D are plan views showing respective display layers in a first embodiment of the invention;

FIGS. 2-8 are isometric views of the first embodiment;

FIGS. 9, 10 and 13-19 are isometric views of a second embodiment of the invention;

FIGS. 11 is a plan view thereof;

FIGS. 12A-12C are elevational views thereof;

FIGS. 20 and 21 are respectively an isometric view and an exploded view of a third embodiment of the invention; including a treated section for supplying diffuse backlight;

FIGS. 22A, C, E, G, I show respective stages in the generation of a subtractive depth map for transparent media; while FIGS. 22B, D, F, H and J show printed display layers corresponding thereto;

FIGS. 23A-E show respective stages in the generation of an additive depth map for opaque media.

FIGS. 24A-24B show a technique for assembling the display layers in the third embodiment;

FIGS. 25A-25B show an alternate version of the third embodiment, in which backlight is supplied by LED's and light guides;

FIGS. 26 and 27 show respectively an interface of a Curve Calculator and a set of calculated data;

FIG. 28 illustrates the problem of banding;

FIG. 29 shows a Table Layer;

FIG. 30 is a schematic view showing the structure of a comp.;

### DETAILED DESCRIPTION OF EMBODIMENTS OF THE INVENTION

We will first discuss the physical structure of four displays embodying the invention. Then a method for generating the images presented in the displays will be discussed in more detail in Section II, below.

I. Display Structure

Four embodiments of the invention will be described.

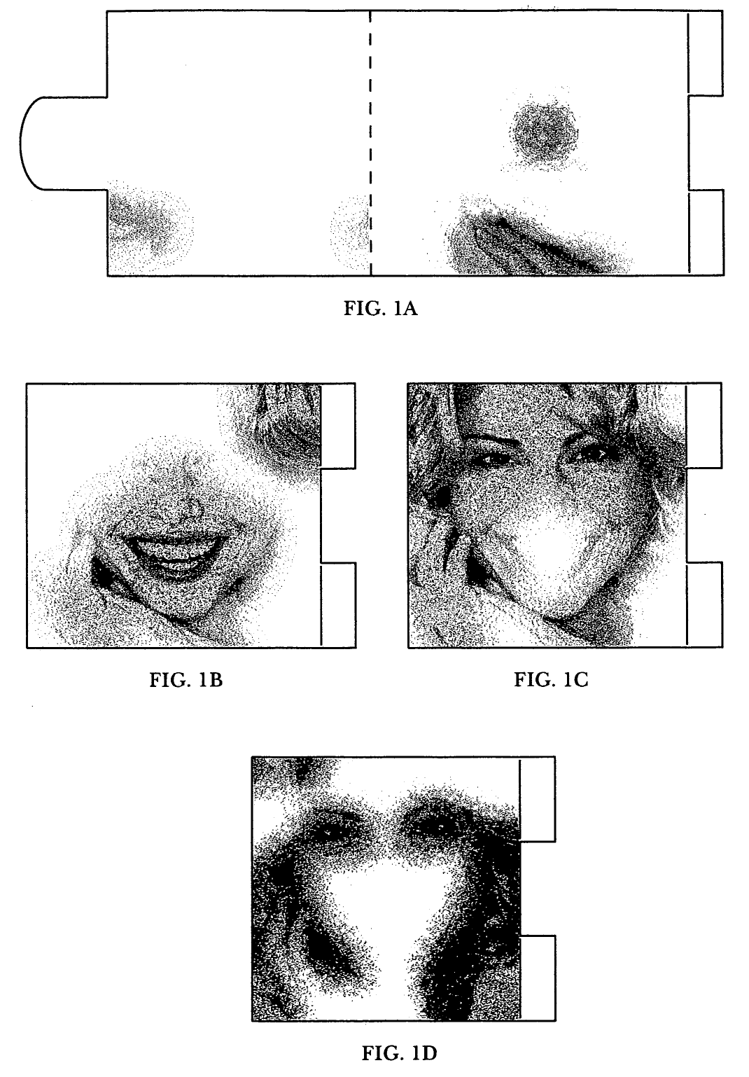

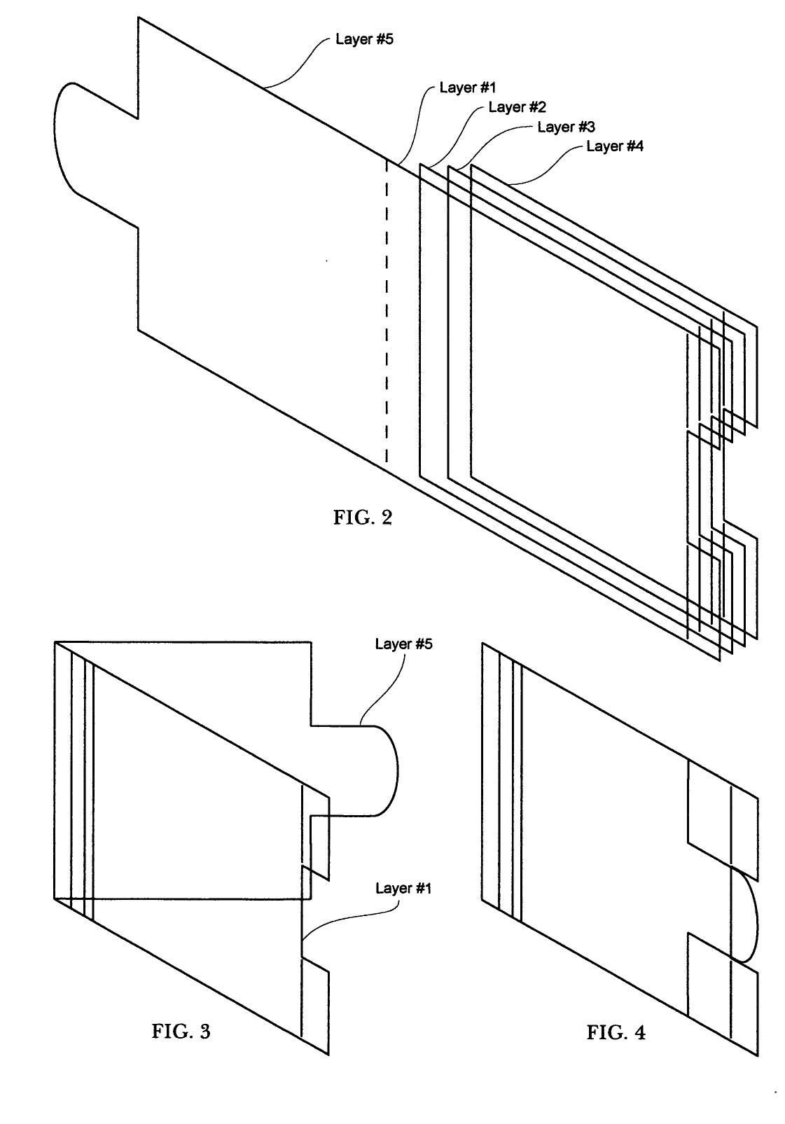

The first embodiment (FIGS. 1A-8) is a configuration that can serve, for instance, either as a magazine insert, a direct mail piece or a greeting card.

The primary use for the second embodiment (FIGS. 9-19) would be as a greeting card or promotional piece.

The third embodiment (FIGS. 20-21) comprises three-dimensional illusions in transparent containers such as clear plastic boxes or illusions embedded in a clear plastic medium such as urethane or polyester.

The first and second embodiments contain two basic elements: one, an insert of bound transparent layers of unequal length that contain image information that has been extracted, distorted and registered so that when the layers are arrayed in the correct position, they comprise a volumetric display that contains an illusion of three-dimensional form; and two, a cover or carrier which binds the insert and cooperates with the bound transparent layers to form a mechanism which, when a tab is pulled or a cover is opened, aligns the layers' edges, such that they form a set of nested approximately catenary-shaped curves of predetermined shape. When the display is configured as a magazine insert, the carrier to which the bound layers attach, and on which they slide, can itself provide a means for attachment, such as for binding into the gutter of a magazine.

The third embodiment is comprised of a transparent container that holds a set of unbound transparent layers of unequal length in alignment such that they form a set of nested approximately catenary-shaped curves of predetermined shape.

The display can be configured with different numbers of layers according to the final effect desired.

When the display is comprised with a pull-tab (FIGS. 1A-8), the image can be oriented so that the tab pulls from the top, bottom, left or right side, depending on the nature of the image and the final effect desired.

When the display is configured in magazine insert form, the tab mechanism may be located on the right side of the display. The left side of the display may be bound into the gutter of the magazine.

When the display is configured as in the first embodiment, the cover may be comprised of a translucent material such as paper or plastic that allows the image to capture light from behind.

When the display is configured in greeting card form (FIGS. 9-19), the cover acts as the “popping” mechanism that activates the display.

Whether as a greeting card or as a magazine insert, the display can be configured with covers in different forms. For instance, the cover may comprise one or more additional leaves folded in some manner to allow for additional area to display information.

Those skilled in the art may conceive of other cover options, which may in some cases be achieved by combining different configurations of the transparent insert and the cover or carrier layer, or by employing different materials for the cover.

### FIRST EMBODIMENT

A first embodiment of a display is presented in FIGS. 1A-8. This example of a display has five image layers #1-#5; and a cover or carrier.

With a front cover the display is adapted to be employed as a greeting card. With the front cover removed, leaving the carrier, the display functions as a magazine insert.

The display in this example depicts a woman's face (FIGS. 1A-1D).

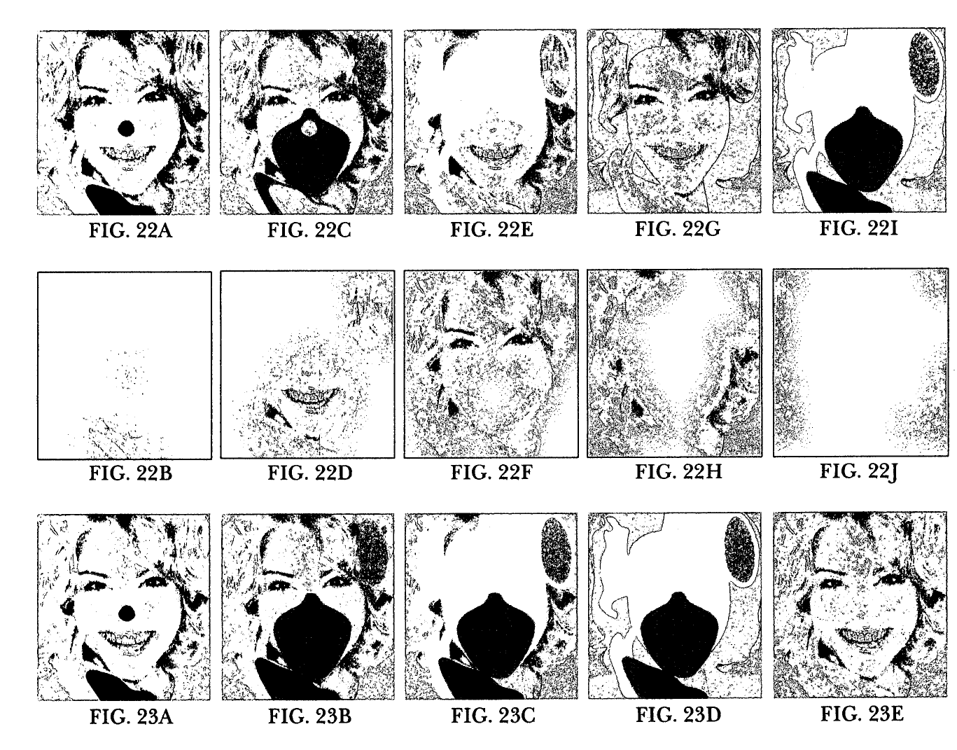

The rectangular transparent image layers are designated Layer #1 through Layer #5 front to back (see FIGS. 22B, 22D, 22F, 22H, 22J). The layers decrease in width from front to back.

To produce an insert, an image is selected and the parameters of a configuration of curved transparent layers are defined and image information is extracted, distorted and printed on a transparent substrate as described below.

The transparent layers are printed, die cut to size and bound by their tabs (see FIG. 2).

In this embodiment of the invention, Layers 1-5 are printed for display as shown in FIGS. 1A-1D. Note that the images on Layers 1-5 become successively narrower in that order. Layers #1 and #5 are printed on the same piece of substrate as illustrated in FIG. 2.

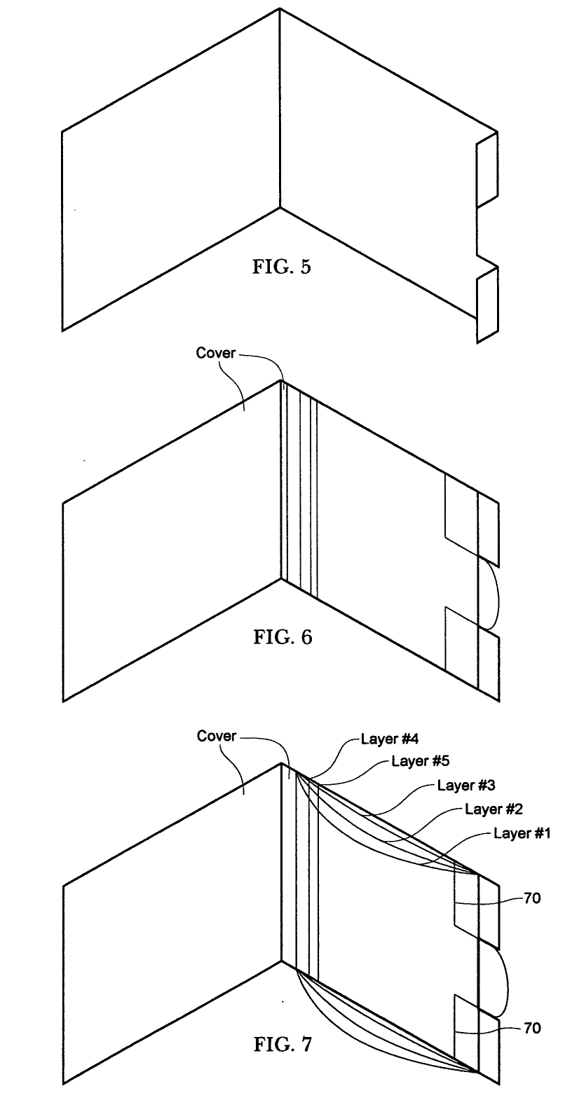

These layers are printed, die cut, collated and then stacked and registered as shown in FIG. 2. Layer #5 is printed backwards so that when it is folded behind the bound layers (see FIGS. 3 and 4) the image is not reversed. The tabs at the right-hand sides of Layers 1-4 are attached together, the left-hand edges being left loose. The tabs themselves, being connected, top and bottom, to their respective layers by small tabs of material, act as hinges allowing each layer to move freely in a vertical plane. A cover or carrier (FIG. 5) that extends beyond Layers 1-5 secures the tabs at the right-hand sides of Layers 1-4 (FIG. 6). The pull-tab of Layer #5 (FIG. 2) is now captured and held in place by the tabs of Layers 1-4 (FIG. 6) that are bound to the cover or carrier.

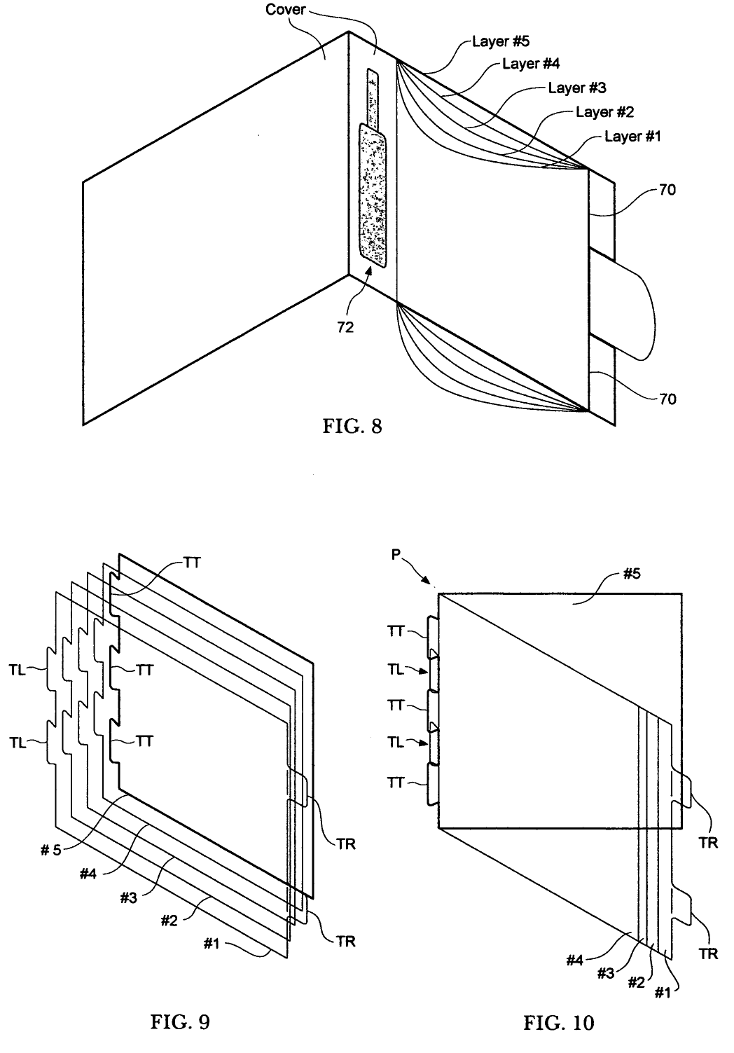

With this structure, when the pull-tab on Layer 5 is pulled rightward (FIG. 7), the fold at the intersection of Layers 1 and 5 moves rightward, pulling with it the free left hand edges of Layers 2-4 so that they “pop” outward, toward the viewer, into a configuration of nested catenary-shaped curves. As shown in FIG. 7, the pull-tab has only been partially pulled to the right, such that the shoulder portions 70 on Layer 5 have not yet reached the bound assembly of the respective tabs on Layers 1-4, and Layer 4 is still resting flat against Layer 5 against the carrier. As the pull-tab continues to be pulled to the right (FIG. 8), the shoulder portions 70 are stopped in their rightward movement by the bound tab assemblies with Layers 1-4 in their fully “popped” position. Layer #5 remains flat against the carrier.

If Layer 5 has been made opaque by some method such as printing it with an undercoat of white ink, it is possible to reveal a hidden image 72 when the card is “popped”.

### SECOND EMBODIMENT

A second embodiment of the display invention is presented in FIGS. 9-19.

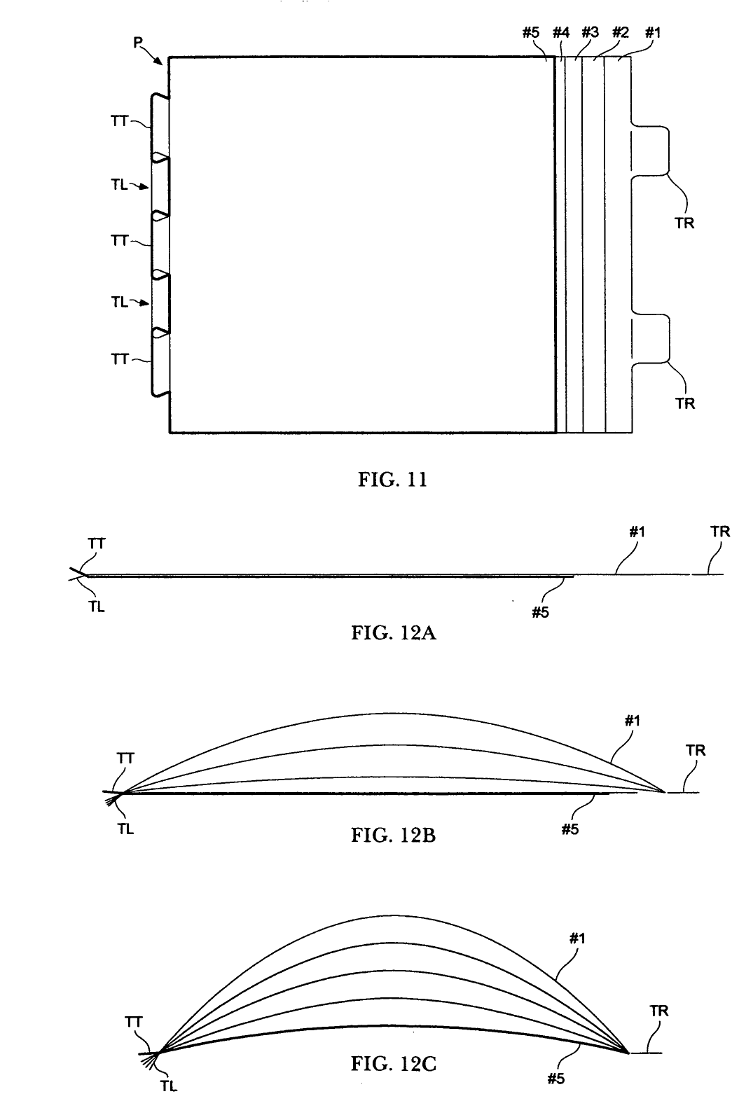

Referringfirst to the exploded view in FIG. 9, this display has five image layers #1-#5, plus an opaque backing layer which is formed integrally with a cover (see FIGS. 15, 17). Layers 1-4 each have two dovetail-shaped tabs TL on the left side. In addition, layer 1 has two tabs TR on the right side for engaging with the cover, as will be discussed below. Layer 5 has three tabs TT on the left side. As best seen in FIG. 10, all of the left tabs TL of layers 1-4 are engaged between the three tabs TT of layer 5 to form a package P, which can then be assembled with the cover C. FIG. 11 is another view of the package P, showing the five layers lying flat and interlocked.

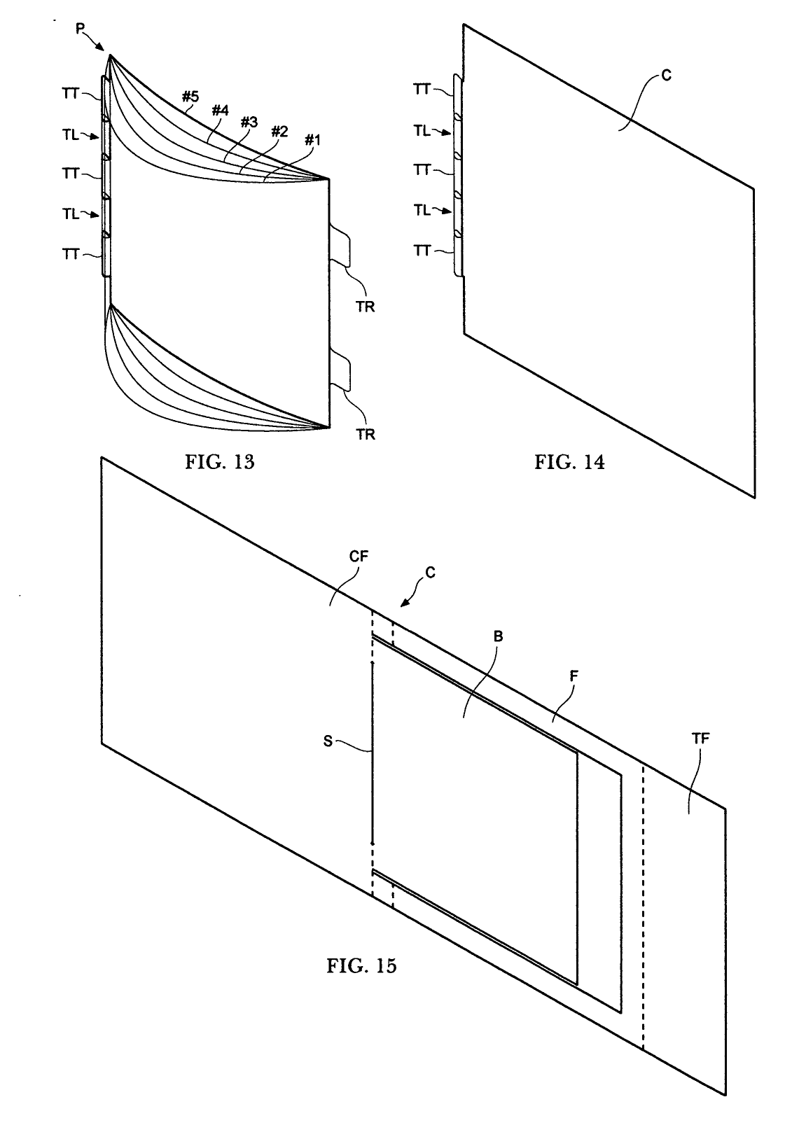

The function of the package P is seen in FIGS. 12A, 12B and 12C and 13. FIGS. 12A-C are schematic end views of the package P, showing the package P in three positions. FIG. 13 is an isometric view corresponding to FIG. 12C. In FIG. 12A, the layers are lying flat. The layers are secured together at the left side by the tabs TT, TL. The layer 1 extends beyond layer 5 on the right side and terminates with the tabs TR. The tabs TR are secured to a stationary part of the cover, and the tabs TT, TL are secured to a movable part of the cover as will be described below. As the left-hand tabs are moved rightward by interaction with the cover, the layers begin to curve and “pop” upwards, to an intermediate position (FIG. 12B) and a fully open position (FIG. 12C). Owing to their different widths the respective layers pop upward by different amounts, with layer #1 attaining the greatest curvature and layer #5 attaining the least curvature.

Referring now to FIG. 14, there is seen the closed cover C containing the package P, with only the tabs TT, TL projecting from the cover C. A slot S (FIG. 15) is formed in the left-hand side of the cover, which is slightly narrower than the total width of the tabs TT, TL. The tabs are inserted into the slot with the package P flexed slightly, so that the tabs are retained in the slot when the package P is released and regains its normal flat shape.

An isometric drawing of the cover blank is presented in FIG. 15. Seen are a front cover CF, an opaque backing sheet B which will be disposed behind the package P and a frame F surrounding the backing sheet, the frame F having a flap TF. Fold lines are marked with dashes in the drawing.

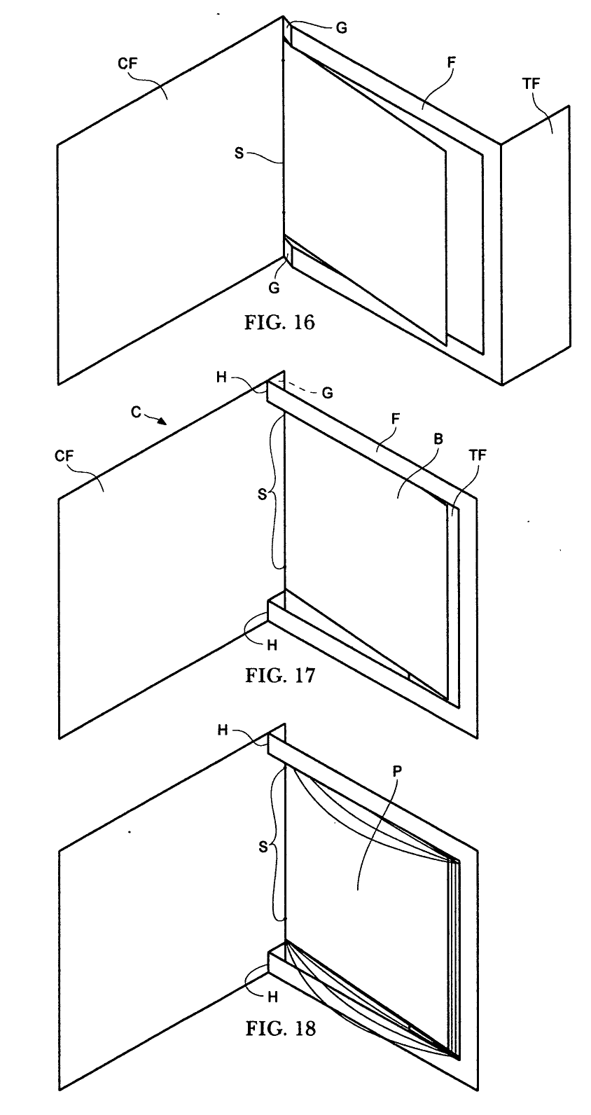

FIG. 16 is an isometric view of the cover C at an intermediate assembly stage, partially folded. At the junction between the front cover CF and the frame F, the fold lines form small areas G of the frame F which will be folded against and glued to the front cover CF to form hinges H between the frame and front cover which are slightly offset from the slot S (see FIG. 17). The flap TF will be folded and glued behind the frame F. FIG. 17 shows the final folded and glued state of the cover C.

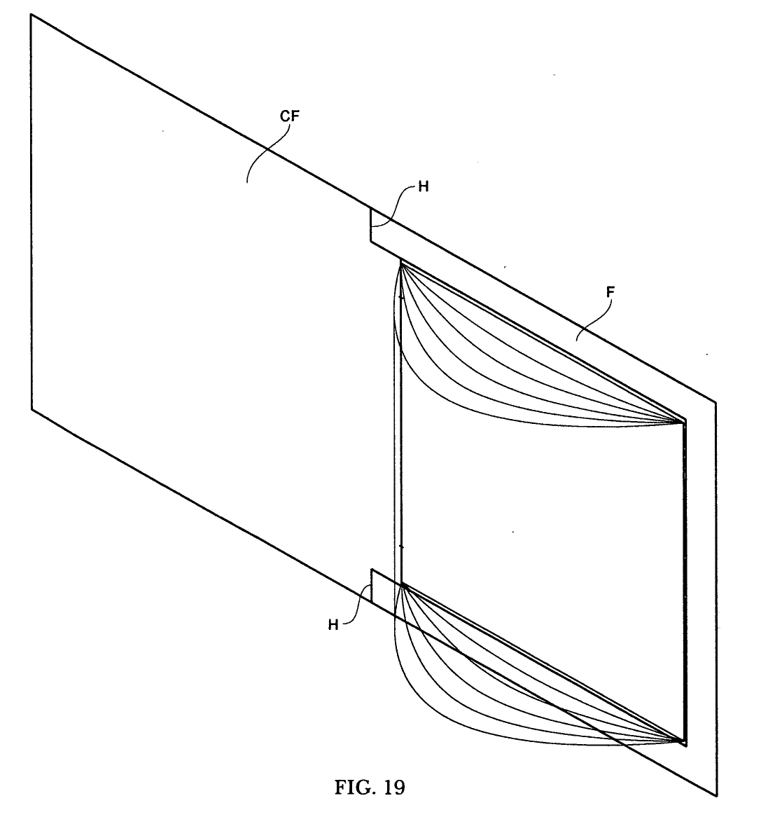

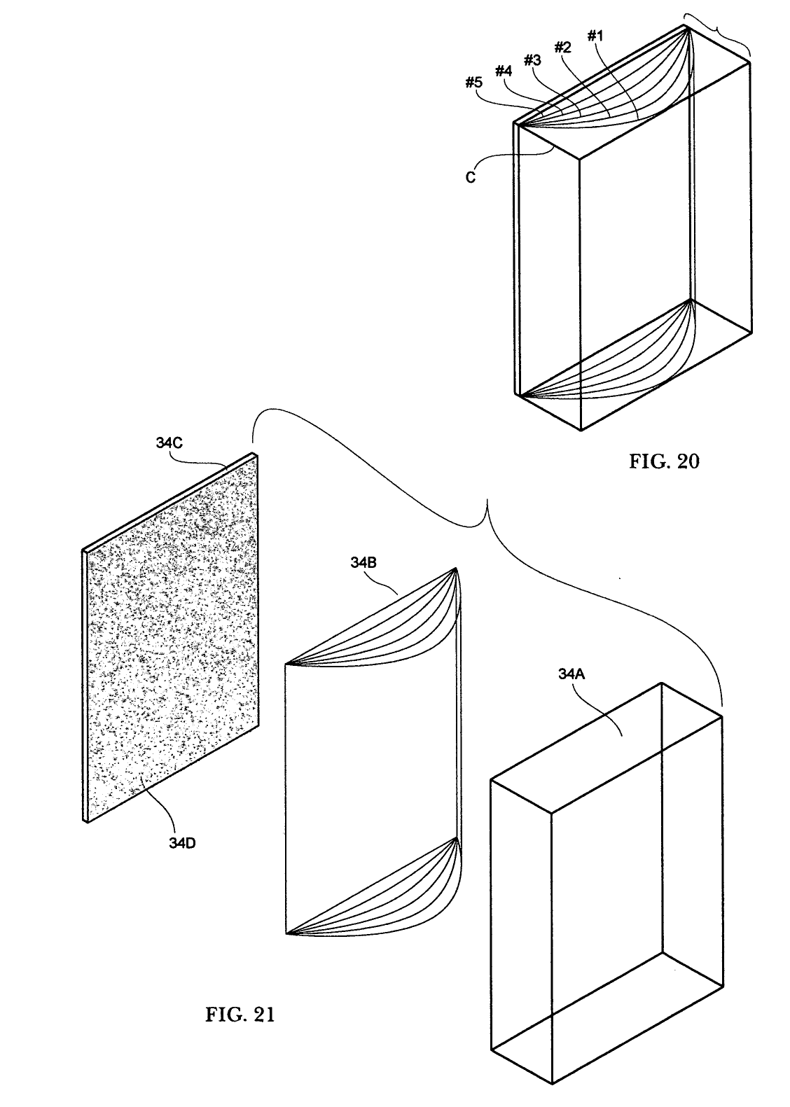

FIGS. 18 and 19 are isometric views showing the cover C combined with the package P and corresponding respectively to the side views in FIGS. 12B and 12C. As the front cover CF is partially opened, it rotates about the hinges H and thereby moves the tabs TF, TT rightward with respect to the frame F. Since the tabs TR of layer #1 are held by the flap TF, the package P is compressed side-to-side by this rightward movement and begins to pop outward. As seen in FIG. 19, as the front cover CF is fully opened, the slot S moves the tabs TF, TT even farther rightward, causing the layers 1-5 to pop their maximum amount out of the frame F and thereby properly orient the images on the respective layers so as to give the intended view of the subject pictured thereon.

### THIRD EMBODIMENT

A third embodiment of the display is presented in FIGS. 20-21, comprising a transparent container C holding curved layers (#1-#5) of unequal length that contain the image information. The width of the box corresponds approximately to the width of the narrowest layer, for example #5 as in the previous embodiments. Because of the gradually increasing width of layers #4-#1, these layers pop upward from #5, forming approximately catenary-shaped layers as seen in FIG. 20 so that a three-dimensional illusion is formed as in the previous embodiments.

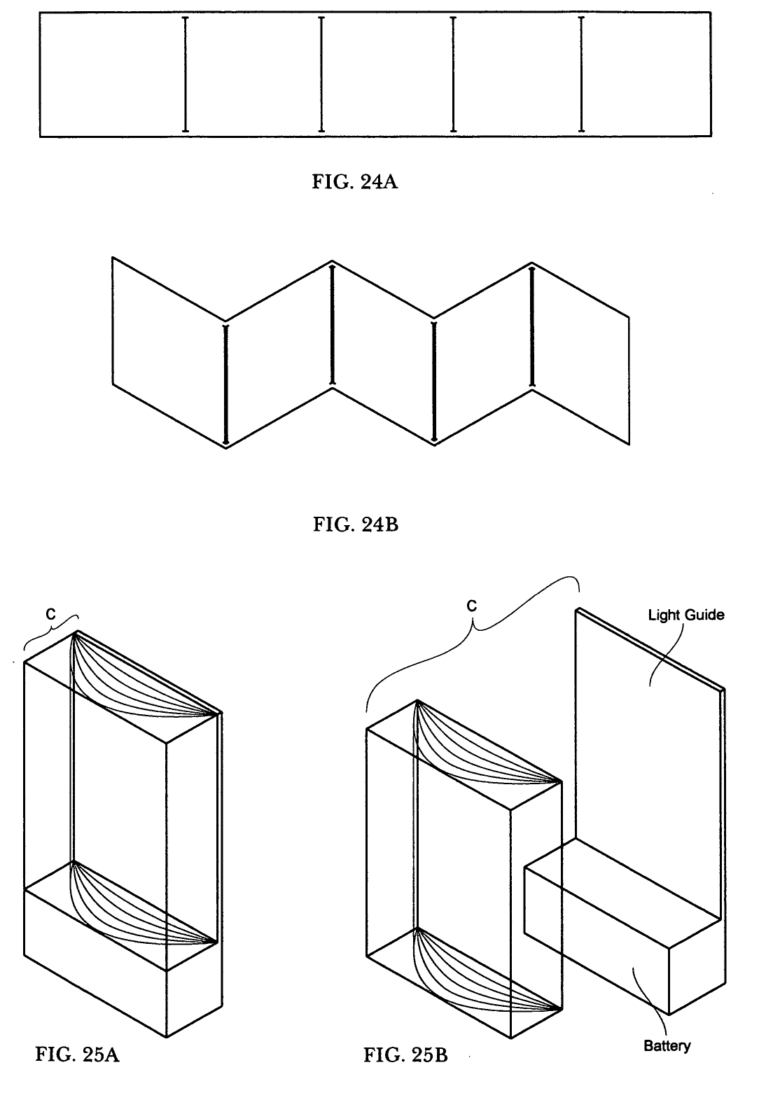

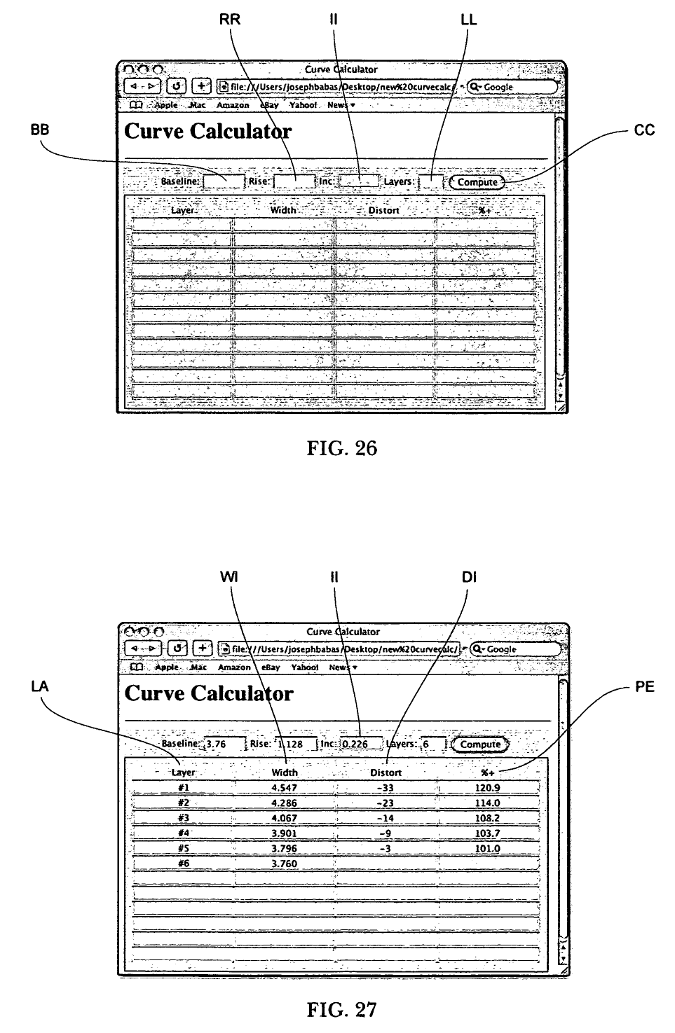

The layers can be configured as separate sheets or they can be configured as a set (FIGS. 24A, 24B) comprised of the separate layers attached to one another on their contiguous vertical edges by small tabs of material that act as hinges allowing each layer to move freely in a vertical plane. The set of layers is then “accordion-folded” into the box. This method requires that the material comprising the small tabs have its “memory” defeated so that the layers are free to form symmetrical curves. This method also requires that every other image, front to back, be printed in reverse, left to right, to accommodate the image reversals caused by the accordion fold.

An exploded view of the box C is shown in FIG. 21. The box C comprises a front section 34a and a back section 34c. The display layers are designated 34b in this figure.

A treated area 34d is also seen in FIG. 21. The area 34d may be an abraded, grooved, etched, etc., area on the inside back of the box, or optionally on the outside, which can be accomplished economically in the injection-molding process. Such treated area creates an efficient and effective diffusion mechanism which spreads available back light through the image with little loss of intensity.

Alternatively, for example, the treated area 34d may be a coating of a phosphorescent pigment on the back of the box that glows in the dark and acts as a backlight for the image.

Referring to FIGS. 25A, 25B, a thin panel configured as a “light guide”, and driven by embedded LED's (not shown) can act as a back light which can be incorporated into the back of the display box C or it can stand alone as a separate element. The backlight can be powered by AC or by battery as shown.

### FOURTH EMBODIMENT

Another embodiment of the invention is disclosed in co-pending Ser. No. 11/______ . In this embodiment, the transparent display layers are flat and are arranged approximately parallel to each other. The image generation techniques to be disclosed herein may be used to generate the images for this embodiment as well.

II. Preparation of the Images

Selecting a Suitable Image

The proper selection of a suitable two-dimensional image to convert to three dimensions is the first step in the method, and it has implications that will affect the efficacy of the finished volumetric display.

In general, if the display comprises convexly curved layers, the finished display will be more effective if the original image comprises an object that is substantially convex in form—e.g., a face, a bottle, a ball, a package, a pill, which provide the opportunity to display continuity of both surface and depth. The technique is also usable, but less effective, with an image that is flat or substantially concave or that is composed, substantially, of small details or linear or planar elements that are not part of a continuous surface and/or that exist apart from one another in distinct planes.

On the other hand, when working with a configuration of concavely curved layers, imagery that is substantially concave would be most effective.

When working with a configuration of flat layers, imagery that is either concave or convex or a combination of both can be effectively displayed.

Once an appropriate image has been chosen, a decision is made concerning how much depth to render, how many layers will be necessary to render that depth and what the nature of the layers' curvature will be.

In most cases, a display comprised of five layers provides ample relative depth resolution and sufficient clarity. Having fewer layers decreases relative depth resolution in the finished display, while having more layers increases relative depth resolution at the cost of reduced clarity in the finished display.

As a rule of thumb, an effective increment, or spacing, between the layers—measured along an axis that is projected at ninety degrees to their surface, and that bisects their curves through their apexes—is 6 to 7% of the image width.

The three-dimensional effect can be modulated in different ways to different effect using traditional psychological cues.

For instance, the three-dimensional image can be rendered in forced perspective, meaning the illusion can be either expanded or foreshortened relative to the proportions of the actual three-dimensional object portrayed in the two-dimensional image.

Depending on the nature of the original image, layers may be spaced closer together or further apart to effect a change in the apparent relative resolution of the entire image or portions of the image.

The hue, chroma and brightness/contrast attributes of an image can also be modulated to give visual cues that will increase or decrease the apparent depth of an image.

Portions of an image can be rendered out of focus to indicate a shortened depth of field.

Blur filters can give the image a sense of movement and also a sense of frozen time.

Depending on the display's final embodiment, the layer configuration may curve substantially away from its background layer either to accommodate or exaggerate a peculiarity of the image or to allow light to fall unimpeded on a background layer.

The curves that fall within the effective parameters of embodiments comprising curved layers closely resemble catenary curves. The resemblance, in fact, is so close that the formulas describing catenary curves can be used as the operators of a Curve Calculator that sets the curves' parameters. The calculator is driven by a Java script that runs on an internet browser. (see Appendix titled “Java Script for Curve Calculator”)

Configuring Curved Layers

Once a decision has been made as to the width, the amount of depth and the number of layers that will be assigned to an image, these values are entered into the Curve Calculator through an interface illustrated in FIG. 37.

Baseline (BB)

The value to be entered in this box represents the width of the image in inches.

Rise (RR)

The value to be entered in this box represents the depth of the image measured in inches from the center of the background, which is furthest from the viewer, to the apex of the foreground layer, which is closest to the viewer.

Inc (II)

This box will contain a value in inches that is a product of calculation. It represents the increment, or spacing, between the layers, measured along an axis that is projected at ninety degrees to the baseline of the curves and that bisects them at their apexes.

Layers (LL)

The value to be entered in this box represents the total number of layers pertinent to the calculation, and it is entered as a variable.

Compute (CC)

This button activates the Curve Calculator.

The variables are entered, the Curve Calculator is activated, and the output is displayed as in FIG. 27.

The computed values are displayed on the interface as follows:

Inc (II)

The computed increment value appears in this box.

Layer (LA)

This column displays the layer numbers in sequential order beginning at the top. Layer #1 in the finished display is closest to the viewer.

Width (WI)

This column displays each layer's width calculated as the length of its catenary curve.

Distort (DI)

This column displays empirically derived values that refer to the appropriate amount of distortion to be applied to each layer by the horizontal option in Photoshop's Spherical Distortion Filter, technically, “cylindrical distortion”. To attain registration of the image information between the layers in the finished display, that information is distorted to a different degree for each layer, relative to that layer's curvature, to accommodate the fact that information derived from a flat surface will be displayed on a curved surface.

Although the curves of the method being disclosed are catenary in nature and the Photoshop Spherical Distortion Filter is based on a spherical model, when the distortion values are applied as adapted, they have been found to map image information accurately enough across the pertinent area of each layer.

Because of the nature of the configuration of the convex layers and the characteristics of suitable imagery, in most cases, the bulk of the pertinent image information in the layers closest to the viewer will normally map symmetrically on either side of a vertical axis through the center of the layers, and the pertinent image information in the layers furthest from the viewer will normally map symmetrically toward the edges of the layers. In other words, the further a layer is from the viewer, the more the information maps toward the edges of the layer in a relatively symmetrical and predictable manner. With this in mind, the empirically derived distortion values apply to, and are sufficiently accurate for, image information to be mapped to particular areas on different layers.

More precisely, to develop the distortion values, using traditional drafting techniques, a linear reference grid was mapped from a flat source onto a curve in question. The reference grid information was then transferred from the curve to a straight line equal in length to the curve. The grid information on the straight line representing the curve was distorted relative to the linear reference grid. After applying an arbitrary value from the Photoshop Spherical Distortion Filter (horizontal only) to the linear reference grid, the reference grid was stretched to equal the length of the straight line representing the curve in question. The areas where the distorted reference grid lined up with the distorted grid on the straight line representing the curve in question defined the areas where image information would map accurately. If no alignment occurred across the two grids, another distortion value was chosen, and the process was repeated until an alignment was achieved that indicated appropriate mapping in the area of interest. This process was repeated with curves of different character until enough data were generated to extrapolate accurate distortion tables that were then incorporated into the Java script that calculates the curve parameters.

Obviously, if the layer configuration consists of cross sections comprised of flat parallel planes, no distortion values need be applied.

And if the layer configuration consists of cross sections whose shapes are more complicated, the general approach can be modified to apply distortions to suit those specific circumstances.

%+(PE)

This column displays values that represent the percentage by which the width of each image layer must be increased to equal the calculated width of each display layer and to move the displaced and distorted image information to the appropriate position on its assigned layer.

Drawing the Depth Map

The operations described below are performed in Adobe Photoshop, which is well known to those skilled in the art. Photoshop elements (e.g., menu choices, tools, settings, keyboard commands, filter options) are printed in boldface, and where there are sequential operations, they are separated by forward slashes (/). The terminology used relates to operations performed using a Macintosh computer. However, the invention is not limited to either that software or that hardware.

The depth map is derived empirically by imagining the two-dimensional information in the image in question, or the “target layer”, as three-dimensional information in space and then visualizing a particular curved layer slicing through that imaginary three-dimensional information.

Drawing a depth map of the target layer is analogous to drawing a topographic map of a piece of land: the final depth map will have contour lines describing the topographic features of the imaginary three-dimensional object represented by the target layer, and that image information—for our purposes, cross sectional information—will be assigned to a particular curved layer according to its appropriate perceived distance from the viewer.

Where the imaginary curved layer intersects the surface of the imaginary three-dimensional object it defines a line that describes the boundary of a section of surface area in the two-dimensional target layer that will be assigned to a particular curved layer. This will be referred to as cross sectional information. And for each curved layer this information is recorded as two-dimensional information on a separate Photoshop layer.

A file the same image size and resolution as the target layer is opened and labeled “Depth Map”. A copy of the Target Layer is cut and pasted to the depth map file.

This process of visualizing, slicing and defining boundaries is applied to the imaginary curved layers 1 thru 4 of our five-layer example (FIGS. 22A, C, E, G). It is not necessary to map the fifth layer since its information is defined by what is left after the information represented by the sum of the other four cross sections has been subtracted from the target layer (FIG. 22I).

Using the pen tool is a convenient way to draw the boundary lines of the cross sections because of the amount of control it offers. The pen tool is used to draw a path; the path is converted into a selection; and the selection is filled with a tonal value.

Filling the area defined by the boundaries of the cross sections on each layer with a different tonal value is a convenient way to visualize the finished depth map (compare with FIGS. 22A, C, E, G, I). Each cross section, which we will now call a “topo”, is assigned a different topo layer number 1 thru 4 (FIGS. 22A, C, E, G). Although the depth map can be compressed and displayed on one layer, assigning each topo to a different topo layer allows the individual topos to be manipulated more easily if changes need to be made in the future.

The topo layers are combined into a Photoshop layer set. The layer set is labeled “Depth Map”.

FIG. 22I illustrates the completed depth map and the individual topo layers for our five-layer example.

Thus, when transparent media are used in this method, the image information in preceding cross sections (the image information in the layers that will be closest to the viewer) is subtracted from subsequent cross sections (the image information in the layers that will be further away from the viewer); and the finished display is most effectively lit from behind.

However, when opaque media are used in this method, the image information in each cross section is utilized in full, thereby repeating much of the information layer to layer; and the finished display is most effectively lit from the top or bottom. (FIGS. 23A-E).

An exception to the above procedure is the cross sectional analysis of a virtual three-dimensional object that exists within a CAD application or a 3D modeling program. Software can be written that takes the specified configuration of curved layers into a drawing or modeling application and manipulates the virtual layer configuration relative to a virtual three-dimensional object. As the spatial relationship between the layer configuration and the three-dimensional object changes, the cross sectional information for each layer can be visually displayed. This information can also be output in two-dimensional form.

Another exception to the above procedure is that if enough geometric information is available concerning the three-dimensional object that is represented by the target layer, the cross sectional information can be derived by hand using traditional drafting techniques.

Extracting Cross Sectional Information

For the cross sectional information of an image displayed on transparent layers to blend most effectively and create the illusion of three-dimensional form, the image information on each layer is graduated in a particular way so that it merges seamlessly with the image information on other layers.

To accomplish this, the topo layers contained in the depth map are used to select and manipulate image information from the target layer. That information is copied to image layers, and those layers are further processed and then used, eventually, to output the layers of the finished display.

This process begins by making a copy of the target layer and labeling it “Image Layer 5”. This layer will function as a Master Target Layer during the extraction process. After the manipulations of the extraction process have been completed, it will function as Image Layer 5.

The manipulations of the extraction process include: defining selections; adding or subtracting selections; expanding selections; feathering selections; and employing modified selections to generate image layers.

A term “E/F”, which we will encounter again below, expresses the ratio of the expand and feather values that are used to manipulate selections.

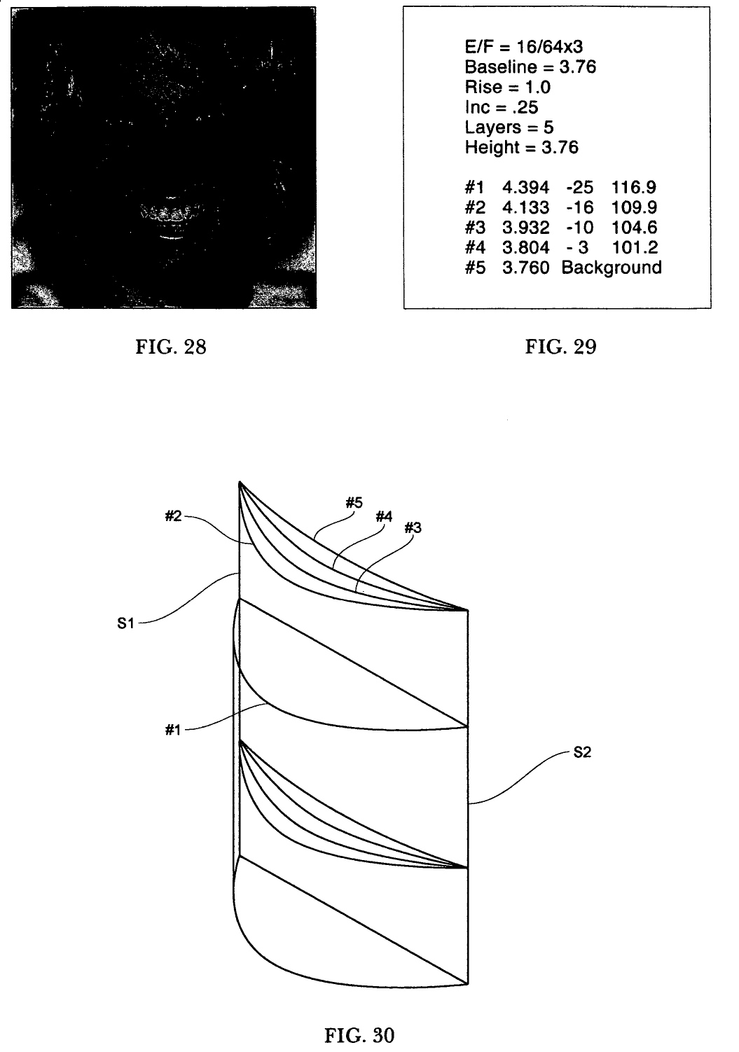

E/F values, which have been derived empirically, can be adjusted through experimentation to suit subjective criteria, but there are practical limitations: if E/F values are too low, the three-dimensional image will suffer from “banding” (FIG. 28); if E/F values are too high, the illusion of depth will be degraded by too much repetition of image information from one layer to the next.

As a rule of thumb, increase of E/F values is related to file size increase by the square root of the factor of file size increase. More precisely, if file size increases by a factor of 16, E/F values increase by the square roof of 16, that is, a factor of 4; if file size increases by a factor of 25, E/F values increase by the square root of 25, that is, a factor of 5.

In general, no matter what the E/F values, for most purposes, the effective ratio in this method is in the neighborhood of 1:4 regardless of file size.

For the example at hand, which has a file size of 3.64 MB, for example, suitable E/F values are 16/64.

For Image Layer 1, the manipulation process begins with selecting Topo Layer 1, FIG. 22A, expanding and feathering that selection using the appropriate E/F values, 16/64, and then copying that modified selection from the Master Target Layer to a new layer which is labeled “Image Layer 1”.

For Image Layer 2, Topo Layer 2 (FIG. 22C) is selected, and then Topo Layer 1 is selected and subtracted from the Topo Layer 2 Selection. This modified selection is then manipulated as described above to generate Image Layer 2.

For Image Layer 3, Topo Layer 3 (FIG. 22E) is selected, and then Topo Layers 1 and 2 are each selected and subtracted from the Topo Layer 3 selection. This modified selection is then manipulated as described above to generate Image Layer #3.

For Image Layer 4, Topo Layer 4 (FIG. 22G) is selected, and then Topo Layers 1, 2 and 3 are each selected and subtracted from the Topo Layer 4 selection. This modified selection is then manipulated as described above to generate Image Layer 4.

For Image Layer 5 there is a different extraction procedure: Topo Layers 1, 2, 3 and 4 are selected and added together (FIG. 13i); these selections are manipulated as described above, and then they are subtracted from the Master Target Layer. The image information now left on the Master Target Layer is manipulated information that is appropriate to Image Layer 5. In other words, what had functioned as the Master Target Layer during the extraction process now functions as Image Layer 5.

The Image Layers are combined into a Layer Set, and the Layer Set is labeled “Image Layers”.

When the Image Layer Set is superimposed over the Photoshop checkerboard background it is apparent that the combined Image Layers lack enough density to completely obscure the checkerboard. This is a function of the feathering process which gradually reduces image density toward the boundaries of the cross sections on each Image Layer.

To create a seamless blending between layers and to fall within appropriate output parameters, the Image Layers need more density.

For the example at hand, each Image Layer is duplicated three times. The duplicated Image Layers are then merged with their original counterparts. Once this process has been applied to all the Image Layers, they will obscure the checkerboard background. This indicates that the Image Layers have the appropriate density.

If the above steps have been properly executed, the superimposed Photoshop layers will combine to create an image that is indistinguishable from the original target image.

If the superimposed layers show a darkening or “banding” where the edges of the individual images overlap, or if the individual images are in any way separately distinguishable when superimposed, the image has been incorrectly processed.

There are two additional procedures necessary to prepare the image for output. One operation distorts the image horizontally relative to a cylindrical model using the “horizontal only” option of the Spherical Distortion Filter. The other operation expands the distorted image horizontally to properly fill its assigned border.

Distorting the Image Information

After the cross sectional information has been extracted from the Target Image, the next step is to transfer the Image Layers Set to a separate Image Layers File where the layers in the set can be distorted and prepared for output.

In the Image Layers File it is convenient to gather the information generated by the Curve Calculator into a “Table Layer” (FIG. 29) on the top layer of the file where it can be easily accessed for future reference.

E/F=16/64×3 (FIG. 29)

This line expresses the relationship between the expand and feather commands employed in the extraction process and tells us that each Image Layer has been copied and merged three times.

Layers=5 (FIG. 29)

This line tells us that the display was calculated with five layers.

Height=3.76 (FIG. 29)

This line gives the opportunity to record the height of the display.

#5 3.760 Background (FIG. 29)

This line represents the width of the original image, which is the same as the width of the Target Layer.

The rest of the information in the Table Layer has been transcribed directly from the Curve Calculator's interface, and it is self-explanatory.

The next step is to generate borders for the Image Layers.

For the example at hand, we will generate borders for each of the Image Layers.

The borders' selections are generated using the rectangular marquee tool; their dimensions are taken from the Table Layer.

The rectangular marquee selections are stroked on the outside with a narrow black border.

Each border is cut and pasted to center it on its Layer, and the Layers are gathered into a layer set labeled “Borders”.

The magic wand is used to select the interior of the Background Layer, and that selection is filled with a gray value; it's called a “slug”.

The Image Layer Set is dragged and dropped from the Depth Map File to the Image Layers File. It is positioned below the Borders Layer Set and the slug.

The Image Layer Set is moved until the Image Layers are completely hidden behind the slug. Since the dimensions of the Image Layer Set and the slug are the same, they are now centered relative to one another.

Select the slug; apply the selection to Image Layer #1; enter the Image Layer 1 distortion factor from the Table Layer into the “filter/distort/spherize/horizontal only” dialog box; hit return; activate the free transform filter; enter the “%+” value for Image Layer #1 into the W box; accept the transform by clicking on the check mark.

Repeat this procedure with Image Layers 2 thru 5.

The next step is to output the distorted and transformed layers to generate a comp that can be used to evaluate the creative decisions made up to this point.

The Image Layers and the Background Layer are output, with their respective Borders, on transparency film.

The Borders are trimmed, and Image Layer #1 and the Background Layer (Layer #5) are fastened together along their vertical sides S1, S2. See FIG. 30.

When Image Layers #2 through #4 are slid between Image Layer #1 and the Background Layer in the proper order, the comp is finished and ready to be evaluated.

The comp can be viewed and evaluated either against a well-lit piece of white paper or on a light box.

Evaluations are made concerning: whether an appropriate image has been chosen; whether it has been prepared properly; whether it has been assigned the appropriate depth; and whether its Depth Map needs to be adjusted.

Once these evaluations have been made and acted upon, a new comp is generated and evaluated.

This process is repeated until a satisfactory comp is generated. At this point the comp can be converted into a particular embodiment using traditional prepress and printing techniques.

Although the present invention has been described in relation to particular embodiments thereof, many other variations and modifications and other uses will become apparent to those skilled in the art. Therefore the present invention is not limited by the specific disclosure herein.

### APPENDIX

```
//  <applet CODE=curvecalc.class width=600 height=350>
//  <PARAM NAME = maxlayers VALUE = 12>
//  <PARAM NAME = border VALUE = 10>
//  <PARAM NAME = baseln_w VALUE = 5>
//  <PARAM NAME = rise_w VALUE = 5>
//  <PARAM NAME = inc_w VALUE = 5>
//  <PARAM NAME = layers_w VALUE = 3>
//  </applet>
import java.text.*;
import java.awt.*;
import java.awt.event.*;
//import java.applet.*;
import java.util.*;
import javax.swing.*;
public class curvecalc extends JApplet implements ActionListener{
  Catenary cat[ ];
  JButton button;
  JTextField baseln,maxh;
  JTextField inc;
  JTextField layers;
  double dbaseln,dmaxh,dinc;
  int nlayers;
  int maxrow,ncol;
  JPanel controlpanel;
  JPanel tabgraph;
  tablePan table;
  int border;
  public void init( ) {
    String st;
    JLabel label;
    int i;
    int baseln_w,rise_w,inc_w,layers_w;
    baseln_w=Integer.parseInt(getParameter(“baseln_w”));
    rise_w=Integer.parseInt(getParameter(“rise_w”));
    layers_w=Integer.parseInt(getParameter(“layers_w”));
    inc_w=Integer.parseInt(getParameter(“inc_w”));
    maxrow=Integer.parseInt(getParameter(“maxlayers”));
    border=Integer.parseInt(getParameter(“border”));
    ncol=4; // 4 columns: # width distort percent
    controlpanel=new JPanel( );
    st=“Baseline:”;
    label=new JLabel(st);
    label.setHorizontalAlignment(JLabel.RIGHT);
    controlpanel.add(label);
    controlpanel.add(baseln=new JTextField(“2.0”,baseln_w));
    // that is the maximum height
    st=“Rise:”;
    controlpanel.add(new JLabel(st,JLabel.RIGHT));
    controlpanel.add(maxh=new JTextField(“1.0”,rise_w));
    // Delta Height
    st=“Inc:”;
    controlpanel.add(new JLabel(st,JLabel.RIGHT));
    controlpanel.add(inc=new JTextField(“”,inc_w));
    inc.setEditable(false);
    // number of layers (includes “flat” layer)
    st=“Layers:”;
    controlpanel.add(new JLabel(st,JLabel.RIGHT));
    controlpanel.add(layers=new JTextField(“2”,layers_w));
    controlpanel.add(button=new JButton(“Compute”));
    button.addActionListener(this);
    table=new tablePan(maxrow,ncol);
    tabgraph=new JPanel(new GridLayout(0,1));
    tabgraph.add(table);
    table.setBorder(BorderFactory.createCompoundBorder(
        BorderFactory.createLineBorder(Color.black),
        //BorderFactory.createTitledBorder(“Table”),
          BorderFactory.createEmptyBorder(border,border,
          border,border)));
    // add panels to main panel
    getContentPane( ).add(controlpanel,BorderLayout.NORTH);
    getContentPane( ).add(tabgraph,BorderLayout.CENTER);
  }
  public void actionPerformed(ActionEvent ev) {
    String label=ev.getActionCommand( );
    if (label.equals(“Compute”)){
      // nlayers also includes flat layer
      // one catenary corresponds to nlayers=2
      nlayers= Integer.parseInt(layers.getText( ).trim( ));
      dbaseln=Double.parseDouble(baseln.getText( ).trim( ));
      dmaxh= Double.parseDouble(maxh.getText( ).trim( ));
      dbaseln=dbaseln<=0.?2.:dbaseln;
      dmaxh=dmaxh<=0.?1.:dmaxh;
      nlayers=Math.min(nlayers,maxrow);
      nlayers=Math.max(nlayers,2); // at least one non-trivial layer
      nlayers−=1; // takes away flat layer now
      cat=new Catenary[nlayers]; // first allocate vector
      double dh=dmaxh/nlayers;
      NumberFormat inc_f = NumberFormat.getInstance( );
      int inc_d=3;
      if (inc_f instanceof DecimalFormat) {
      ((DecimalFormat) inc_f).setMaximumFractionDigits(inc_d);
      ((DecimalFormat) inc_f).setMinimumFractionDigits(inc_d);
      }
      inc.setText(“”+inc_f.format(dh));
      double ht=dmaxh;
      // allocate each catenary (nlayers−1, since last is flat)
      for(int i=0;i<nlayers;i++){
      cat[i]=new Catenary(dbaseln*.5,ht);
      ht−=dh;
      }
      // now update table
      table.fill(cat,nlayers);
    }
  }
}
class tablePan extends JPanel{
  // ‘width’ is meant to hold arc-length (misnomer)
  int maxrow,ncol;
  int layer_d,width_d,distort_d,percent_d;
  int layer_ha,width_ha,distort_ha,percent_ha; // horizontal alignment
  JTextField cell[ ][ ];
  Interpolation distort;
  tablePan(int mr,int mc){
    super(new GridLayout(0,mc));
    int cellwidth=4;
    cell=new JTextField[mr][mc];
    distort=new Interpolation( ); // creates interpolation class
    int i,j;
    StringTokenizer st=new StringTokenizer(“Layer Width Distort %+”);
    while(st.hasMoreTokens( )){
      add(new JLabel(st.nextToken( ),JLabel.CENTER));
    }
    for (i=0;i<mr;i++){
      for (j=0;j<mc;j++){
      add(cell[i][j]=new JTextField(“”,cellwidth));
      cell[i][j].setEditable(false);
      cell[i][j].setHorizontalAlignment(JTextField.CENTER);
      }
    }
    maxrow=mr;
    ncol=mc;
    this.erase( );
  }
  void erase( ){
    int i,j;
    for (i=0;i<maxrow;i++){
      for (j=0;j<ncol;j++){
      cell[i][j].setText(“”);
      }
    }
  }
  void fill(Catenary cat[ ],int m){
    int i,j;
    double bhratio;
    erase( );
    // precision for each field
    layer_d=0;
    width_d=3;
    distort_d=0;
    percent_d=1;
    NumberFormat width_f = NumberFormat.getInstance( );
    NumberFormat percent_f = NumberFormat.getInstance( );
    NumberFormat distort_f = NumberFormat.getInstance( );
    if (width_f instanceof DecimalFormat) {
      ((DecimalFormat) width_f).setMaximumFractionDigits(width_d);
      ((DecimalFormat) width_f).setMinimumFractionDigits(width_d);
    }
    if (percent_f instanceof DecimalFormat) {
      ((DecimalFormat)
      percent_f).setMaximumFractionDigits(percent_d);
      ((DecimalFormat)
      percent_f).setMinimumFractionDigits(percent_d);
    }
    if (distort_f instanceof DecimalFormat) {
      ((DecimalFormat) distort_f).setMaximumFractionDigits(distort_d);
      ((DecimalFormat) distort_f).setMinimumFractionDigits(distort_d);
    }
    for (i=0;i<m;i++){
      bhratio=2*cat[i].l/cat[i].h;
      cell[i][0].setText(“ #”+(i+1)); //layer
      cell[i][1].setText(“”+(width_f.format(cat[i].s))); //arclength (width)
      //cell[i][2].setText(“”+(distort_f.format((bhratio))));
cell[i][2].setText(“”+(distort_f.format(distort.interpolate(bhratio))));
      cell[i][3].setText(“”+(percent_f.format(50*cat[i].s/cat[i].l)));
    }
    // last layer only with width
    cell[m][0].setText(“ #”+(i+1));
    cell[m][1].setText(“”+(width_f.format(2*cat[0].l)));
  }
}
class Interpolation{
  double X[ ],M[ ],P[ ]; // Y=MX+P (linear interpolation)
  int N;
  Interpolation( ){
    int n=17; // 17 sample points below
    double x[ ]={1.973,
        2.364,
        2.466,
        2.967,
        3.607,
        3.705,
        3.864,
        4.167,
        4.810,
        4.952,
        5.909,
        7.214,
        9.863,
        11.818,
        14.429,
        14.971,
        25.000
    };
    double mm[ ]={25.5754475703,
      78.4313725490,
      3.9920159681,
      20.3125000000,
      10.2040816327,
      12.5786163522,
      3.3003300330,
      9.3312597201,
      7.0422535211,
      3.1347962382,
      2.2988505747,
      1.1325028313,
      0.5115089514,
      0.7659900421,
      1.8450184502,
      0.0997108386,
      0.0000000000
    };
    double pp[ ]={−110.4603580563,
      −235.4117647059,
      −51.8443113772,
      −100.2671875000,
      −63.8061224490,
      −72.6037735849,
      −36.7524752475,
      −61.8833592535,
      −50.8732394366,
      −31.5235109718,
      −26.5839080460,
      −18.1698754247,
      −12.0450127877,
      −15.0524703179,
      −30.6217712177,
      −4.4927709642,
      −2.0000000000
    };
    N=n;
    X=new double[n]; M=new double[n]; P=new double[n];
    for (int i=0;i<n;i++) {
      X[i]=x[i]; M[i]=mm[i]; P[i]=pp[i];
    }
  }
  double interpolate(double xx) {
    // returns the linearly interp. value
    int i;
    double yy;
    // first must find which interval
    if (xx<=X[0]) {
      i=0;
    }
    else {
      for (i=1;i<N;i++) {
      if (xx<=X[i]) {
        break;
      }
      }
      i−−;
    }
    // here i contains the right index for interpolation
    yy=M[i]*xx+P[i];
    return yy;
  }
}
class Catenary{
  /*
    Catenary through points (+/−l,o) and (0,−h):
    y(x)=k*(cosh(x/k)−1) −h
  */
  double h,l,k,s; // s is arclength between (+/−l,0)
  double lambda; // lambda is ratio l/k
  Catenary(double ll,double hh){
    h=hh;
    l=ll;
    lambda=ll/hh;
    this.solvefork( );
    s=Math.exp(l/k);
    s=s−1./s;
    s*=k;
  }
  Catenary(double lh){
    this(lh,lh);
  }
  Catenary( ){
    this(1.);
  }
  void seth(double hh){
    h=hh;
    lambda=l/h;
  }
  void solvefork( ){
    /*
    Newton Method for solving for parameter k
    Hardcodes function, derivative and initial step
    Original eqn: cosh(l/k)−h/k−1=0
    Change via x=h/k into
    phi(x)=cosh(lx/h)−x−1=0
    */
    int i,maxit=101;
    double Tol;
    double x,dx,explx;
    double coshlx, sinhlx;
    double phi,phiprime;
    x=2./(lambda*lambda);
    Tol=x*1e−6;
    for(i=1;i<maxit ;i++){
      explx=Math.exp(lambda*x);
      coshlx=.5*(explx+1/explx);
      sinhlx=.5*(explx−1/explx);
      phi=coshlx−1−x;
      if (Math.abs(phi)<Tol)
      break;
      phiprime=lambda*sinhlx−1; // derivative
      dx=phi/phiprime;
      x−=dx;
    }
    k=h/x;
  }
}
```

What is claimed is:

1. A method of preparing a three-dimensional display of an object, comprising the steps of:
defining a plurality of depth zones corresponding to respective portions of said object taken in a depth direction from the front toward the back of the object;
preparing a two-dimensional image of each said depth zone;
placing each said depth zone image on a respective one of a plurality of transparent display layers with said images in front-to-back alignment;
spacing said display layers apart from one another so that viewing said images from front to back provides a three-dimensional display of the object.

2. The method of claim 1, wherein said step of defining said depth zones includes the steps of providing a two-dimensional image of said object and selecting said depth zones as portions of said two-dimensional image.

3. The method of claim 2, further comprising the step of feathering said depth zone images as applied to said display layers.

4. The method of claim 1, wherein said display layers are curved.

5. The method of claim 4, wherein said display layers are curved from side to side in an approximate catenary shape and convexly toward the viewer.

6. The method of claim 4, further comprising the step of distorting each said depth zone image according to the curvature of the respective display layer.

7. A volumetric display, comprising:
a supporting carrier having a fixed portion and a movable portion;
a plurality of transparent display layers having respective widths from a first side to an opposite second side;
wherein said respective widths decrease from a top one to a bottom one of said layers;
at least one of said layers being linked to said fixed portion of said carrier at said second side:
at least one of said layers being linked to said movable portion of said carrier at said first side;
wherein an actuating movement of said movable carrier portion from a first position to a second position is effective to bring said first sides and said second sides of said layers into substantial alignment, whereby at least said top layer having the greatest width is caused to bulge upward forming a curved display surface.

8. The volumetric display of claim 7, wherein each said display layer has thereon a partial image which is a portion of an overall image, said partial images being substantially out of alignment when said carrier is in said first position, and being substantially in alignment when said carrier is in said second position.

9. The volumetric display of claim 8, wherein said movable carrier portion is attached to said top layer at said first side and said actuating movement is in a direction from said first side toward said second side.

10. The volumetric display of claim 8, wherein said movable portion of said carrier is hinged to said fixed portion whereby said actuating movement is a rotational movement.

11. A volumetric display, comprising:
a plurality of transparent display layers having respective widths from a first side to an opposite second side;
wherein said respective widths decrease from a top one to a bottom one of said layers;
said plurality of display layers being disposed in a container having a top through which said display layers are viewable;
said container having a width substantially less than at least a top one of said layers, whereby said top layer bulges upward forming a curved display surface.
